(19) United States
(12) Patent Application Publication
(10) Pub. No.: US 2026/0364632 A1
(43) Pub. Date: Nov. 19, 2026

(54) Extrusion coated substrates for packaging applications

(71) Applicant: BOREALIS GMBH, Vienna (AT)

(72) Inventors: Jingbo Wang, Linz (AT); Friedrich Berger, Linz (AT); Jani AHo, Porvoo (FI); Auli Nummila-Pakarinen, Kullo (FI)

(21) Appl. No.: 19/138,763

(22) PCT Filed: Dec. 28, 2023
(86) PCT No.: PCT/EP2023/087898

§ 371 Date: Jun. 13, 2025

(30) Foreign Application Priority Data
Dec. 29, 2022 (EP) 22217182.9

(51) Int. Cl. B05D 7/04; B05D 1/26

(52) U.S. Cl. CPC B05D 7/04; B05D 1/265; B05D 2201/02; B05D 2507/015

(57) ABSTRACT

An extrusion coated substrate comprising a coating layer, wherein the coating layer comprises at least a multimodal polyethylene copolymer (P) having a MFR2 of from 0.5 to 20 g/10 min, a density of from 910 to 915 kg/m³ and comprising a first bi- or multimodal polyethylene copolymer fraction (A) having a density of from 920 to 950 kg/m³, a MFR2 of from 2 to 200 g/10 min and a comonomer content of from 0.5 to 5 wt %, and a second polyethylene homo- or copolymer fraction (B) having a density of from 880 to 915 kg/m³, a MFR2 of from 0.01 to 6 g/10 min and a comonomer content of from 15 to 25 wt. %; wherein a ratio MFR21/MFR2 of said multimodal ethylene copolymer (P) is in a range of from more than 20 to 100 and a process for producing the same. Further, an extrusion coated substrate comprising a MDO PE substrate with a thickness in the range of from 10 to 200 μm and a tensile modulus in machine direction in a range of from 300 to 2000 MPa; a coating layer comprising 60 to 99 wt. % of a multimodal mLLDPE homo- or copolymer (Px) having a density in a range of from 910 to 920 kg/m³ and MFR2 of 0.5 to 20 g/10 min; and 1 to 40 wt. % of a low density polyethylene (C) having a density of 910 to 925 kg/m³ and MFR2 of 2 to 40 g/10 min; wherein a ratio MFR2(C) to MFR2(P) is greater than 1.

The present invention relates to extrusion coated substrates comprising a coating layer, wherein the coating layer comprises at least a multimodal polyethylene homo- or copolymer (P), an extrusion coated substrate comprising a polyethylene substrated and a coating layer comprising at least a multimodal polyethylene homo- or copolymer (P), a process for producing an extrusion coated substrate and the use of a coating composition in extrusion coating.

Plastic packaging is widely used for a vast variety of products. In order to meet the various requirements of packaging applications, it has become customary in the field to rely on multilayer structures. Multilayer structures usually comprise various different materials, in particular a substrate (for example paper, cardboard, polymer films or aluminium foil) and one or more coating layers and may be obtained via extrusion coating.

WO2005/002744 discloses conventional extrusion coated substrates for packaging applications. The extrusion coated substrate comprises a substrate, in particular a substrate being paper, cardboard, a polyester film, cellophane, polyamide film, polypropylene film, oriented polypropylene film or aluminium foil, and a coating layer comprising a PE composition.

Likewise, WO98/30628 discloses an extrusion coating structure comprising at least one layer made of a polymer composition comprising a multimodal ethylene polymer. According to the specification, the polymer composition of WO98/30628 is suitable for extrusion coating of fiber based materials like paper and paperboard. Alternatively, the substrate used in the extrusion coating can be a plastic film made of e.g. polyester, polyamide, polypropylene or cellophane.

Moreover, EP1265959 discloses a process for coating a substrate, wherein the coating is typically extruded on a fiber based substrate material, such as paper or paperboard (cardboard). The substrate can also be a film made of polyester, cellophane, polyamide, polypropylene or oriented polypropylene.

As already mentioned, the main advantage of such multi-material, multilayer structures lays in the good balance of properties that may be achieved.

However, recycling of conventional multi-material extrusion coated substrates is difficult, if not impossible. Therefore, the provision of a mono-material extrusion coated substrate is envisaged.

The main issue to be overcome with mono-material extrusion coated substrates is a good balance of properties, especially low seal initiation temperature (SIT) combined with high stiffness.

### DESCRIPTION OF THE INVENTION

The present invention is directed to an extrusion coated substrate comprising a coating layer, wherein the coating layer comprises at least a multimodal ethylene copolymer (P) having an MFR₂ of from 0.5 to 20 g/10 min, a density of from 910 to 915 kg/m³ and comprising a first bi- or multimodal copolymer fraction (A) having a density of 920 to 950 kg/m³, MFR₂ of 2 to 200 g/10 min and a comonomer content of from 0.5 to 5 wt. %, based on the total weight of the first bi- or multimodal copolymer fraction (A), and a second ethylene homo- or copolymer fraction (B) having a density of 880 to 915 kg/m³, MFR₂ of 0.01 to 6 g/10 min and a comonomer content of from 15 to 25 wt. %, based on the total weight of the second ethylene homo- or copolymer fraction (B); wherein a ratio MFR₂₁ to MFR₂ (MFR₂₁/MFR₂) of said multimodal ethylene homo- or copolymer (P) is in a range of from more than 20 to 100.

Further, the invention is directed to an extrusion coated substrate comprising a machine-direction oriented polyethylene (MDO PE) substrate with a thickness in a range of from 10 to 200 μm and a tensile modulus in machine direction in a range of from 300 to 2000 MPa; and a coating layer comprising from 60 to 99 wt % of a metallocene low linear density polyethylene (mLLDPE) copolymer (P) having a density in a range of from 910 to 920 kg/m³ and a MFR₂ of 0.5 to 20 g/10 min, and from 1 to 40 wt. % of a low density polyethylene (C) having a density of from 910 to 925 kg/m³ and a MFR₂ of 2 to 40 g/10 min; wherein a ratio MFR_{2(C)} to MFR_{2(P)} is greater than 1.

Unexpectedly the extrusion coated substrates of the invention exhibit improved sealing properties, such as especially low sealing initiation temperature (SIT) in combination with improved mechanical properties such as high stiffness.

In addition, the invention is also directed to a process for producing an extrusion coated substrate comprising extruding a coating composition onto a substrate to obtain the extrusion coated substrate, wherein said coating composition comprises a mLLDPE copolymer (P) having an MFR₂ of 0.5 to 20 g/10 min, a density of from 910 to 915 kg/m³ and comprising a first bi- or multimodal ethylene copolymer fraction (A) having a density of 920 to 950 kg/m³, a MFR₂ of 2 to 200 g/10 min and a comonomer content of from 0.5 to 5 wt. %, based on the total weight of the first bi- or multimodal ethylene copolymer fraction (A), and a second ethylene homo- or copolymer fraction (B) having a density of 880 to 915 kg/m³, a MFR₂ of 0.01 to 6 g/10 min and a comonomer content of from 15 to 25 wt. %, based on the total weight of the second ethylene homo- or copolymer fraction (B), wherein a ratio MFR₂₁/MFR₂ of said multimodal ethylene copolymer (P) is in a range of from more than 20 to 100.

Moreover, the invention is directed to the use of a coating composition comprising a mLLDPE copolymer (P) having an MFR₂ of 0.5 to 20 g/10 min, a density of from 910 to 915 kg/m³ and comprising a first bi- or multimodal ethylene copolymer fraction (A) having a density of 920 to 950 kg/m³, a MFR₂ of 2 to 200 g/10 min and a comonomer content of from 0.5 to 5 wt. %, based on the total weight of the first bi- or multimodal ethylene copolymer fraction (A), and a second ethylene homo- or copolymer fraction (B) having a density of 880 to 915 kg/m³, a MFR₂ of 0.01 to 6 g/10 min and a comonomer content of from 15 to 25 wt. %, based on the total weight of the second ethylene homo- or copolymer fraction (B), in an extrusion coated substrate, wherein the substrate is a MDO PE film.

### Extrusion Coated Substrate

According to a first embodiment, the present invention is directed to an extrusion coated substrate comprising a coating layer, wherein the coating layer comprises at least a multimodal ethylene copolymer (P) having an MFR₂ of from 0.5 to 20 g/10 min, a density of from 910 to 915 kg/m³ and comprising a first bi- or multimodal copolymer fraction (A) having a density of 920 to 950 kg/m³, MFR₂ of 2 to 200 g/10 min and a comonomer content of from 0.5 to 5 wt. %, and a second ethylene homo- or copolymer fraction (B) having a density of 880 to 915 kg/m³, MFR₂ of 0.01 to 6 g/10 min and a comonomer content of from 15 to 25 wt. %; wherein a ratio MFR₂₁ to MFR₂ (MFR₂₁/MFR₂) of said multimodal ethylene homo- or copolymer (P) is in a range of from more than 20 to 100.

The multimodal polyethylene copolymer (P) is preferably produced in the presence of a metallocene catalyst. Hence, expressions like “metallocene produced multimodal polyethylene copolymer (P)” or “metallocene catalysed multimodal copolymer (P)” may be used herein to refer to the multimodal polyethylene copolymer (P). As used herein, the term “metallocene low linear density polyethylene” (mLLDPE) refers to metallocene produced low linear density polyethylene.

The multimodal polyethylene copolymer (P) is referred herein as “multimodal” since the ethylene-1-butene polymer component (A), including ethylene polymer fractions (A-1) and (A-2), and ethylene-1-hexene polymer component (B) have been produced under different polymerization conditions resulting in different Melt Flow Rates (MFR, e.g. MFR₂), i.e. the multimodal PE is multimodal at least with respect to difference in MFR of the ethylene polymer components (A) and (B).

According to a particularly preferred embodiment, the multimodal polyethylene copolymer (P) consists of
(i) 30.0 to 70.0 wt % of an ethylene-1-butene polymer component (A), and
(ii) 70.0 to 30.0 wt % of an ethylene-1-hexene polymer component (B).

The amount of (A) and (B) add up to 100.0 wt %.

In said particularly preferred embodiment, the ethylene-1-butene polymer component (A) may consist of an ethylene polymer fraction (A-1) and (A-2), whereby the MFR₂ of the ethylene polymer fractions (A-1) and (A-2) may be different from each other.

The ethylene polymer fraction (A-1) has a MFR₂ (190 °C, 2.16 kg, ISO 1133) in the range of 1.0 to 20.0 g/10 min, preferably of 1.5 to 18.0 g/10 min, more preferably of 2.0 to 16.0 g/10 min and even more preferably of 2.5 to 14.0 g/10 min, like 3.0 to 12.0 g/10 min.

The ethylene polymer fraction (A-2) has a MFR₂ (190 °C, 2.16 kg, ISO 1133) in the range of 3.0 to 40.0 g/10 min, preferably of 3.2 to 30.0 g/10 min, more preferably of 3.5 to 20.0 g/10 min and most preferably of 3.5 to 10.0 g/10 min.

The MFR₂ of the ethylene polymer components (A) and (B) are different from each other.

The ethylene polymer component (A) has a MFR₂ (190 °C, 2.16 kg, ISO 1133) in the range of 2.0 to 200 g/10 min, preferably of 2.0 to 40 g/10 min, more preferably of 2.5 to 30 g/10 min, still more preferably of 3.0 to 20 g/10 min and even more preferably of 3.2 to 10 g/10 min.

The ethylene polymer component (B) has a MFR₂ (190 °C, 2.16 kg, ISO 1133) in the range of 0.01 to 6 g/10 min, preferably of 0.01 to 1.5 g/10 min, more preferably of 0.05 to 1.5 g/10 min, still more preferably of 0.1 to 1.2 g/10 min and even more preferably of 0.2 to 1.0 g/10 min.

The MFR₂ (190 °C, 2.16 kg, ISO 1133) of the multimodal copolymer (P) is in the range of 0.5 to 20.0 g/10 min, preferably of 0.5 to 2.0 g/10 min, more preferably of 0.8 to 1.8 g/10 min, still more preferably 1.0 to 1.5 g/10 min.

The multimodal copolymer (P) has a ratio of the MFR₂₁ (190 °C, 21.6 kg, ISO 1133) to MFR₂ (190 °C, 2.16 kg, ISO 1133), MFR₂₁/MFR₂, in the range of from more than 20 to 100, preferably from 22 to 50, more preferably from 25 to 40 and even more preferably from 28 to 35.

In an embodiment of the invention it is preferred the ratio of the MFR₂ (190 °C, 2.16 kg, ISO 1133) of ethylene-1-butene polymer component (A) to the MFR₂ (190 °C, 2.16 kg, ISO 1133) of the final multimodal copolymer (P) is at least 2.5 to 20.0, preferably 3.0 to 15.0 and more preferably of 3.5 to 10.0.

Naturally, in addition to multimodality with respect to, i.e. difference between, the MFR₂ of ethylene polymer components (A) and (B), the multimodal PE of the invention can also be multimodal e.g. with respect to one or both of the two further properties:
multimodality with respect to, i.e. difference between,
   the comonomer content(s) present in the ethylene polymer components (A) and (B); and/or
   the density of the ethylene polymer components (A) and (B).

Preferably, the multimodal copolymer (P) is further multimodal with respect to the comonomer content of the ethylene polymer components (A) and (B).

The comonomer type for the polymer fractions (A-1) and (A-2) is the same, thus, preferably, both fractions comprise 1-butene as comonomer.

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (mol %) in component B=(comonomer content (mol %) in final product−(weight fraction of component A*comonomer content (mol %) in component A))/(weight fraction of component B)

The total amount of 1-butene, based on the multimodal polymer (P) is preferably in the range of from 0.1 to 1.0 wt %, preferably 0.2 to 0.8 wt % and more preferably 0.3 to 0.6 wt %.

The total amount of 1-hexene, based on the multimodal polymer (P) preferably is in the range of 2.0 to 20.0 wt %, preferably 4.0 to 18.0 wt % and more preferably 6.0 to 15.0 wt %.

The total amount (wt %) of comonomer, preferably 1-butene, present in the ethylene-1-butene polymer component (A) is of 0.5 to 5.0 wt %, preferably of 0.8 to 4.0 wt %, more preferably of 1.0 to 3.0 wt %, even more preferably of 1.0 to 2.0 wt %, based on the ethylene-1-butene polymer component (A).

The total amount (wt %) of comonomer, preferably 1-hexene, present in the ethylene-1-hexene polymer component (B) is of 15.0 to 25.0 wt %, preferably of 16.0 to 22.0 wt %, more preferably of 17.0 to 20.0 wt %, based on the ethylene-1-hexene polymer component (B).

Even more preferably the multimodal polymer (P) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 920 to 950 kg/m³, preferably of 925 to 950 kg/m³, more preferably 930 to 945 kg/m³ and/or the density of the ethylene polymer component (B) is of in the range of 880 to 915 kg/m³, preferably of 885 to 905 kg/m³ and more preferably of 888 to 900 kg/m³.

The polymer fraction (A-1) has a density in the range of from 920 to 960 kg/m³, preferably of 925 to 955 kg/m³, more preferably of 930 to 950 kg/m³, like 935 to 945 kg/m³.

The density of the polymer fraction (A-2) is in the range of from 930 to 950 kg/m³, preferably of 935 to 945 kg/m³.

The metallocene catalysed multimodal copolymer (P) is preferably a linear low density polyethylene (LLDPE) which has a well known meaning.

The density of the multimodal copolymer (P) is in the range of 910 to 915 kg/m³.

More preferably the multimodal copolymer (P) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

Furthermore, according to a preferred embodiment, polymer component (A) may be characterized by an isolated 1-butene comonomer unit amount of >95.0%, preferably at least 98.0% and more preferably 100%. The isolated comonomer unit amount is calculated according to formula (I)

$$EXE \% = 100 * \frac{EXE}{EXE + EXX + XXX}$$

wherein X being the number of 1-butene branches per 1000 carbon (kCb).

In addition, according to the above preferred embodiment, polymer component (B) may have an isolated 1-hexene comonomer unit amount according to formula (I), wherein X being the number of 1-hexene branches per 1000 carbon (kCb); fulfilling the equation

EXE %>−1.1875*C6 (of (B) in wt %)+110.41

More preferably, the ethylene-1-hexene polymer component (B) fulfils the equation

EXE %>−1.1875*C6 (of (B) in wt %)+111.41, more preferably

EXE %>−1.1875*C6 (of (B) in wt %)+112.41 and even more preferably

EXE %>−1.1875*C6 (of (B) in wt %)+113.41.

The isolated 1-hexene comonomer unit amount for component (B) is preferably >92.0%, preferably at least 93.0% and more preferably at least 94.0%.

A suitable upper limit is <100%, preferably 99.0%, more preferably 98.0%.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 30.0 to 70.0 wt % based on the multimodal copolymer (P), preferably in an amount of 32.0 to 55.0 wt % and even more preferably in an amount of 34.0 to 45.0 wt %.

Thus, the ethylene polymer component (B) is present in an amount of 70.0 to 30.0 wt % based on the multimodal copolymer (P), preferably in an amount of 68.0 to 45.0 wt % and more preferably in an amount of 66.0 to 55.0 wt %.

The metallocene catalysed multimodal copolymer (P) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2021009189, WO 2021009190, WO 2021009191 and WO 2021009192. Full details of how to prepare suitable metallocene catalysed multimodal copolymer (P) can be found in these references as well as in the experimental part herein below.

A suitable process is the Borstar PE process or the Borstar PE 3G process. The metallocene catalysed multimodal copolymer (P) is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal copolymer (P). This can counted as part of the first ethylene polymer component (A).

The substrate to be comprised in the extrusion coated substrate according to the first embodiment of the present invention preferably comprises a machine-direction oriented polyethylene (MDO PE) film or a biaxially-stretched polyethylene film; a MDO PE film being more preferred.

Particularly preferred substrates to be comprised in the extrusion coated substrate according to the present invention are MDO PE films having a density of from 920 to 970 kg/m³ determined according to ISO1183, MFR₂ of 0.1 to 2.0 g/10 min, MFR₂₁ of 4 to 150 g/10 min determined according to ISO1133, and melting temperature of 120 to 140 °C determined according to ISO11357-3. The MDO PE substrate may be blocked or unblocked. For the blocked film type structure the multilayer coextruded film exits the die in the form of a bubble, the bubble is cut, i.e. the formed bubble is collapsed e.g. at the nip rolls to form said film and then the two halves forced together to effectively form the multilayer structure. In this way, the film thickness is effectively doubled and the desired initial film thickness achieved. This is called film blocking in the art.

According to a second embodiment, the present invention is further directed to an extrusion coated substrate comprising a MDO PE substrate with a thickness in the range of from 10 to 200 μm and a tensile modulus in machine direction in a range of from 300 to 2000 MPa; an extrusion coating layer comprising from 60 to 99 wt. % of a multimodal mLLDPE homo- or copolymer (Px) having a density in a range of from 910 to 920 kg/m³ and MFR₂ of 0.5 to 20 g/10 min; and from 1 to 40 wt. % of a low density polyethylene (C) having a density of 910 to 925 kg/m³ and MFR₂ of 2 to 40 g/10 min; wherein a ratio MFR_{2(C)} to MFR₂ (Px) is greater than 1.

Preferably, the MDO PE substrate to be comprised in the extrusion coated substrate according to the present invention has a density of from 920 to 970 kg/m³ determined according to ISO1183, a MFR₂ of 0.1 to 2.0 g/10 min, a MFR₂₁ of 4 to 150 g/10 min determined according to ISO1133 and a melting temperature of 120 to 140 °C determined according to ISO11357-3. The MDO PE substrate may be blocked or unblocked.

Preferably, the multimodal mLLDPE homo- or copolymer (Px) comprises a multimodal polyethylene copolymer (P) as detailed above.

The low density polyethylene (C) having a density of from 910 to 925 kg/m³ and a MFR₂ of 2 to 40 g/10 min may further be characterized by the following specifications. The low density polyethylene (C) may be a homo- or copolymer of ethylene. The LDPE (C) may comprise from 0 to 10 wt. % of a comonomer, preferably from 0 to 7 wt. %, more preferably from 0 to 3 wt. %. Suitable comonomers to be comprised in LDPE (C) may be selected from acrylic comonomers, preferably from vinyl acrylate, butyl acrylate and methyl acrylate; more preferably the comonomer comprised in LDPE (C) is vinyl acrylate.

Preferably the LDPE (C) is an ethylene homopolymer, such as for example Polyethylene CT7200 commercially available from Borealis AG.

The extrusion coated substrates according to either the first or the second embodiment of the present invention may further be characterized by the following specifications.

Preferably, the thickness of the (uncoated) substrate is in a range of from 10 to 200 μm.

Preferably, the coating layer is present in the extrusion coated substrate in an amount of from 5 to 50 g/m².

Preferably, the overall thickness of the extrusion coated substrate is in a range of from 15 to 250 μm.

Preferably, the extrusion coated substrates according to the invention comprise at least 90 wt. %, more preferably at least 95 wt. %-based on the total weight of the extrusion coated substrate- and even more preferably consist of ethylene homo- or copolymers.

Preferably, the extrusion coated substrates according to the invention have a seal initiation temperature (SIT) of from 90 °C or less, more preferably of from 85 °C or less as determined herein below in the experimental section.

Preferably, the extrusion coated substrates according to the invention have a tensile modulus in machine direction (TM/MD) of at least 600 MPa, more preferably of at least 625 MPa, even more preferably of at least 650 MPa.

Preferably, the extrusion coated substrates according to the invention have a tensile modulus in transverse direction (TM/TD) of at least 480 MPa, more preferably of at least 500 MPa and even more preferably of at least 515 MPa.

Tensile modulus of the extrusion coated substrates is measured in machine and/or transverse direction according to ISO 527-3 on film samples as detailed in the experimental section.

The extrusion coated substrates according to the present invention may be used in packaging applications, in particular food packaging applications.

### Process

The present invention is directed to a process for producing an extrusion coated substrate comprising extruding a coating composition onto a substrate to obtain the extrusion coated substrate, wherein said coating composition comprises a multimodal polyethylene copolymer (P) having an MFR₂ of from 0.5 to 20 g/10 min, a density of from 910 to 915 kg/m³ and comprising a first bi- or multimodal polyethylene copolymer fraction (A) having a density of 920 to 950 kg/m³, MFR₂ of 2 to 200 g/10 min and a comonomer content of from 0.5 to 5 wt. %, and a second polyethylene homo- or copolymer fraction (B) having a density of 880 to 915 kg/m³; MFR₂ of 0.01 to 6 g/10 min and comonomer content of from 15 to 25 wt. %; wherein a ratio MFR₂₁/MFR₂ of said multimodal polyethylene homo- or copolymer (P) is in a range of from more than 20 to 100.

Preferably, in the process described above, the (uncoated) substrate comprises an polyethylene homo- or copolymer film, preferably a machine-direction oriented polyethylene homo- or copolymer film.

Alternatively, it is also possible to use a biaxally stretched polyethylene homo- or copolymer film as the substrate in the process described above.

Generally speaking, extrusion coating is a process in which an extruder forces melted thermoplastic trough a horizontal slot onto a moving web of a substrate material. The substrate material in most cases is paper, board, film or aluminium foil. The goal is to improve the properties of the substrate(s). The melt stream can be used as a coating layer or as an adhesive to bond two separate webs together

Further details regarding extrusion coating processes are given, for example in WO2005/002744 or EP1265959 A1.

### Use of a Coating Composition

In yet a further aspect, the present invention is directed to the use of a coating composition comprising a multimodal polyethylene copolymer (P) having an MFR₂ of 0.5 to 20 g/10 min, a density of from 910 to 915 kg/m³ and comprising a first bi- or multimodal polyethylene copolymer fraction (A) having a density of 920 to 950 kg/m³, a MFR₂ of 2 to 200 g/10 min and a comonomer content of from 0.5 to 5 wt. %, and a second polyethylene homo- or copolymer fraction (B) having a density of 880 to 915 kg/m³, a MFR₂ of 0.01 to 6 g/10 min and a comonomer content of from 15 to 25 wt. %, in an extrusion coated substrate, wherein the substrate is a MDO PE film.

The multimodal polyethylene copolymer (P) comprised in the coating composition corresponds to the multimodal polyethylene copolymer (P) as described herein above in detail. All preferred embodiments of the multimodal polyethylene copolymer (P) apply equally in the context of the coating composition and the use thereof.

### Experimental Data

### Determination Methods

Unless otherwise stated in the description or in the experimental part, the following methods were used for the property determinations of the polymers (including its fractions and components) and/or any sample preparations thereof as specified in the text or experimental part.

### a) Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR is determined at 190 °C for polyethylene. MFR may be determined at different loadings such as 2.16 kg (MFR₂), 5 kg (MFR₅) or 21.6 kg (MFR₂₁).

### b) Density

Density of the polymer was measured according to ASTM D792, Method B (density by balance at 23 °C) on compression moulded specimen prepared according to EN ISO 1872-2 and is given in kg/m³.

### c) Comonomer Content

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for ¹H and ¹³C respectively. All spectra were recorded using a ¹³C optimized 7 mm magic-angle spinning (MAS) probehead at 150 °C using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilizing the NOE at short recycle delays of 3 s {pollard04, klimke06} and the RS-HEPT decoupling scheme{fillip05, griffin07}. A total of 1024 (1k) transients were acquired per spectra.

Quantitative ¹³C{¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (δ+) sites at 30.00 ppm accounting for the number of reporting sites per monomer:

E=I_{δ+}/2

the presence of isolated comonomer units is corrected for based on the number of isolated comonomer units present:

Etotal=E+(3*B+2*H)/2

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

fBtotal=Btotal/(Etotal+Btotal+Htotal)

The amount isolated 1-butene incorporated in EEBEE sequences was quantified using the integral of the _{*}B2 sites at 39.8 ppm accounting for the number of reporting sites per comonomer:

B=I_{*B2}

If present the amount consecutively incorporated 1-butene in EEBBEE sequences was quantified using the integral of the ααB2B2 site at 39.4 ppm accounting for the number of reporting sites per comonomer:

BB=2*IααB2B2

If present the amount non consecutively incorporated 1-butene in EEBEBEE sequences was quantified using the integral of the ββB2B2 site at 24.6 ppm accounting for the number of reporting sites per comonomer:

BEB=2*IββB2B2

Due to the overlap of the *B2 and *βB2B2 sites of isolated (EEBEE) and non-consecutively incorporated (EEBEBEE) 1-butene respectively the total amount of isolated 1-butene incorporation is corrected based on the amount of non-consecutive 1-butene present:

B=I_{*B2}−2*I_{ββB2B2}

Sequences of BBB were not observed. The total 1-butene content was calculated based on the sum of isolated, consecutive and non consecutively incorporated 1-butene:

Btotal=B+BB+BEB

The total mole fraction of 1-butene in the polymer was then calculated as:

fB=Btotal/(Etotal+Btotal+Htotal)

Characteristic signals corresponding to the incorporation of 1-hexene were observed and the comonomer fraction calculated as the fraction of 1-hexene in the polymer with respect to all monomer in the polymer:

fHtotal=Htotal/(Etotal+Btotal+Htotal)

The amount isolated 1-hexene incorporated in EEHEE sequences was quantified using the integral of the _{*}B4 sites at 38.3 ppm accounting for the number of reporting sites per comonomer:

H=I_{*B4}

If present the amount consecutively incorporated 1-hexene in EEHHEE sequences was quantified using the integral of the ααB4B4 site at 40.5 ppm accounting for the number of reporting sites per comonomer:

HH=2*IααB4B4

If present the amount non consecutively incorporated 1-hexene in EEHEHEE sequences was quantified using the integral of the ββB4B4 site at 24.7 ppm accounting for the number of reporting sites per comonomer:

HEH=2*IββB4B4

Sequences of HHH were not observed. The total 1-hexene content was calculated based on the sum of isolated, consecutive and non consecutively incorporated 1-hexene:

Htotal=H+HH+HEH

The total mole fraction of 1-hexene in the polymer was then calculated as:

fH=Htotal/(Etotal+Btotal+Htotal)

The mole percent comonomer incorporation is calculated from the mole fraction:

B[mol %]=100*fB

H[mol %]=100*fH

The weight percent comonomer incorporation is calculated from the mole fraction:

B[wt %]=100*(fB*56.11)/((fB*56.11)+(fH*84.16)+((1−(fB+fH))*28.05))

H[wt %]=100*(fH*84.16)/((fB*56.11)+(fH*84.16)+((1−(fB+fH))*28.05))

References: Klimke, K., Parkinson, M., Piel, C., Kaminsky, W., Spiess, H. W., Wilhelm, M., Macromol. Chem. Phys. 2006; 207:382; Parkinson, M., Klimke, K., Spiess, H. W., Wilhelm, M., Macromol. Chem. Phys. 2007; 208:2128; Pollard, M., Klimke, K., Graf, R., Spiess, H. W., Wilhelm, M., Sperber, O., Piel, C., Kaminsky, W., Macromolecules 2004; 37:813; Filip, X., Tripon, C., Filip, C., J. Mag. Resn. 2005, 176, 239; Griffin, J. M., Tripon, C., Samoson, A., Filip, C., and Brown, S. P., Mag. Res. in Chem. 2007 45, S1, S198; Castignolles, P., Graf, R., Parkinson, M., Wilhelm, M., Gaborieau, M., Polymer 50 (2009) 2373; Busico, V., Cipullo, R., Prog. Polym. Sci. 26 (2001) 443; Busico, V., Cipullo, R., Monaco, G., Vacatello, M., Segre, A. L., Macromoleucles 30 (1997) 6251; Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128; Resconi, L., Cavallo, L., Fait, A., Piemontesi, F., Chem. Rev. 2000, 100, 1253.

### d) DSC Analysis

Melting temperature Tm and Crystallization temperature Tc were measured with a TA Instrument Q2000 differential scanning calorimetry (DSC) on 5 to 7 mg samples. DSC is run according to ISO 11357/part 3/method C2 in a heat/cool/heat cycle with a scan rate of 10 °C/min in the temperature range of −30 to +225 °C. Crystallization temperature was determined from the cooling step, while melting temperature (Tm) and melting enthalpy (Hm) are determined from the second heating step.

### e) Tensile Modulus

Tensile modulus, given in MPa, was measured at 23 °C in machine and/or transverse direction according to ISO 527-3 on film samples produced as indicated below and at a cross head speed of 1 mm/min for the modulus.

### f) Seal Initiation Temperature

The method determines the sealing temperature range (sealing range) of polyethylene films, in particular blown films or cast films. The sealing temperature range is the temperature range, in which the films can be sealed according to conditions given below.

The lower limit (heat sealing initiation temperature (SIT)) is the sealing temperature at which a sealing strength of 5 N is achieved. The upper limit (sealing end temperature (SET)) is reached, when the films stick to the sealing device.

The measurement was done according to the slightly modified ASTM F1921-12, where the test parameters sealing pressure, cooling time and test speed have been modified. The determination of the force/temperature curve was continued until thermal failure of the film.

The sealing range was determined on a J&B Universal Sealing Machine Type 4000 with film samples produced as indicated below with the following further parameters:
Conditioning time: >96 h
Specimen width: 25 mm
Sealing pressure: 0.4 N/mm² (PE)
Sealing time: 1 sec
Delay time: 30 sec
Sealing jaws dimension: 50×5 mm
Sealing jaws shape: flat
Sealing jaws coating: Niptef
Sealing temperature: ambient −240 °C.
Sealing temperature interval: 5 °C.
Start temperature: 50 °C
Grip separation rate: 42 mm/sec

### Materials

MDO PE film: 3-layered MDO PE film having an overall density of 939 kg/m³ and comprising a first outer layer (O1) having an overall density of 954 kg/m³ and comprising 85 wt. % of a first polyethylene polymer having a density of 960 kg/m³ and a MFR₂ of 0.7 g/10 min and 15 wt. % of a second polyethylene polymer having a density of 918 kg/m³ and a MFR₂ of 1.5 g/10 min; an inner layer (I) having an overall density of 931 kg/m³ and comprising a polyethylene polymer having a density of 931 kg/m³ and a MFR₅ of 0.9 g/10 min; and a second outer layer (O2) having an overall density of 960 kg/m³ and comprising a first polyethylene polymer having a density of 960 kg/m³ and a MFR₂ of 0.7 g/10 min; the layer distribution in the MDO PE film being 15% (O1), 70% (I) and 15% (O2) based on the total thickness of the stretched MDO PE film. The total thickness of the stretched MDO PE film is 25 μm after stretching at a drawdown ratio of 4:1.
PE1: commercially available ethylene based octene-1 plastomer, produced in a solution polymerisation process using a metallocene catalyst; density 910 kg/m³; MFR₂ 1.1 g/10 min; melting temperature 106 °C; SIT 87 °C.
PE2: commercially available LDPE homopolymer; density 918 kg/m³; MFR₂ 5.0 g/10 min.

### Multimodal Polyethylene Copolymer (P)

Borstar pilot plant with a 3-reactor set-up (loop1-loop2-GPR 1) and a prepolymerization loop reactor.

The multimodal polyethylene copolymer (P), used in inventive example 1 (IE1) and also denoted as “PE3” was produced by using the polymerization conditions as given in Table 1.

### Preparation of Metallocene Catalyst (CAT1)

### Loading of SiO2:

10 kg of silica (PQ Corporation ES757, calcined 600 °C) was added from a feeding drum and inertized in the reactor until 02 level below 2 ppm was reached.

### Preparation of MAO/tol/MC:

30 wt % MAO in toluene (14.1 kg) was added into another reactor from a balance followed by toluene (4.0 kg) at 25 °C (oil circulation temp) and stirring 95 rpm. Stirring speed was increased 95 rpm->200 rpm after toluene addition, stirring time 30 min. Metallocene Rac-dimethylsilanediylbis {2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10 °C (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25 °C). After stirring “dry mixture” was stabilised for 12 h at 25 °C (oil circulation temp), stirring 0 rpm. Reactor was turned 20° (back and forth) and stirring was turned on 5 rpm for few rounds once an hour.

After stabilisation the catalyst was dried at 60 °C (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Compounding

The polymers were mixed with 2400 ppm of Irganox B561. 270 ppm of Dynamar FX 5922 compounded and extruded under nitrogen atmosphere to pellets by using a JSW extruder so that the SEI was 230 kWh/kg and the melt temperature 250 °C.

TABLE 1

| | IE1 |
|---|---|
| Prepoly reactor | |
| Catalyst | CAT1 |
| Catalyst feed (g/h) | 35 |
| Temp. (°C) | 50 |
| Press. (kPa) | 5639 |
| C2 (kg/h) | 4.0 |
| H2(g/h) | 0.04 |
| C4 (g/h) | 81.9 |
| Split (wt %) | 3.4 |
| loop 1/ Fraction (A-1) | |
| Temp. (°C) | 85 |
| Press. (kPa) | 5544 |
| C2 conc. (mol %) | 3.5 |
| H2/C2 ratio (mol/kmol) | 0.41 |
| C4/C2 ratio (mol/kmol) | 41 |
| Split (wt %) | 17.6 |
| Density (kg/m³) of loop 1 material (fraction (A-1)) | 941 |
| MFR₂ (g/10 min) of loop 1 material (fraction (A-1)) | 5.0 |
| loop 2 | |
| Temp. (°C) | 85 |
| Press. (kPa) | 5325 |
| C2 conc. (mol %) | 3.5 |
| H2/C2 ratio (mol/kmol) | 0.6 |
| C4/C2 ratio (mol/kmol) | 29 |
| Split (wt %) | 20.4 |
| Density (kg/m3) after loop 2 (component (A)) | 940.7 |
| MFR₂ (g/10 min) after loop 2 (component (A)) | 5.8 |
| MFR₂ (g/10 min) of loop 2 material (fraction (A-2)) | 6.8 |
| Density (kg/m³) of loop 2 material (fraction (A-2)) | 941 |
| C4 (wt %) after loop 2 material (Component (A)) | 1.21 |
| GPR | |
| Temp. (°C) | 75.0 |
| Press. (kPa) | 2000.0 |
| H2/C2 ratio (mol/kmol) | 1.18 |
| C6/C2 ratio (mol/kmol) | 14.5 |
| Split (wt %) | 58.6 |
| MFR₂ (g/10 min) of GPR material (Component (B)) | 0.5 |
| Density (kg/m³) of GPR material (Component (B)) | 891 |
| C6 (wt %) of GPR material Component (B)) | 18.60 |

TABLE 2

| Material | IE1 |
|---|---|
| MFR₂ (g/10 min) (final) | 1.3 |
| MFR₂₁ (g/10 min) | 38.7 |
| MFR₂₁/MFR₂ | 29.8 |
| Density (kg/m³) | 913 |
| C4 (wt %) | 0.5 |
| C6 (wt %) | 10.7 |
| MFR₂(A)/MFR₂(final) | 4.5 |
| EBE (kCb ) | 1.3 |
| EBB (kCb) | 0 |
| BBB (kCb) | 0 |
| EBE (%) | 100 |
| EHE (kCb) | 16 |
| EHH (kCb) | 0.9 |
| HHH (kCb) | 0 |
| EHE (%) | 94.7 |
| Film Properties | |
| SIT [°C] | 71 |
| Tensile Modulus MPa (MD/TD) | 155/158 |

### Extrusion Coating Process

Extrusion coating runs were made on Beloit coextrusion coating line. It had a Peter Cloeren's die and a five layer feed block. The width of the line was 850 −1000 mm and the maximum line speed was 1000 m/min (design value).

In the coating line above a (un)blocked MDO PE substrate (details given above) having a thickness of 25 μm was coated with a coating layer of IE1/CE1 (see table 3) having a basis weight of 30 g/m². The temperature of the polymer melt was set to 300 °C. The line speed was 100 m/min.

TABLE 3

| | | IE1 | CE1 |
|---|---|---|---|
| Substrate | | MDO PE film | MDO PE film |
| Coating Layer | | 70 wt. % PE3 + | 70 wt. % PE1 + |
| | | 30 wt. % PE2 | 30 wt. % PE2 |
| SIT | °C | 85 | 94 |
| TM/MD | MPa | 650 | 597 |
| TM/TD | MPa | 519 | 478 |

As evidenced by IE1, an extrusion coated substrate according to the present invention combines high density with low SIT. Moreover, the stiffness (TM) of the extrusion coated substrate of IE1 is significantly higher than in case of CE1 even though the (uncoated) substrate is identical for both IE1 and CE1.

1. An extrusion coated substrate comprising a coating layer, wherein the coating layer comprises at least:
a multimodal polyethylene copolymer (P) having a MFR₂ of from 0.5 to 20 g/10 min, a density of from 910 to 915 kg/m³ and comprising:
a first bi- or multimodal polyethylene copolymer fraction (A) having a density of from 920 to 950 kg/m³, a MFR₂ of from 2 to 200 g/10 min and a comonomer content of from 0.5 to 5 wt. %, based on the total weight of the first bi- or multimodal copolymer fraction (A), and
a second polyethylene homo- or copolymer fraction (B) having a density of from 880 to 915 kg/m³, a MFR₂ of from 0.01 to 6 g/10 min and a comonomer content of from 15 to 25 wt. %, based on the total weight of the second ethylene homo- or copolymer fraction (B);
wherein a ratio MFR₂₁/MFR₂ of said multimodal ethylene copolymer (P) is in a range of from more than 20 to 100, MFR₂ and MFR₂₁ being determined according to ISO1133.

2. Extrusion coated substrate according to claim 1, wherein the coating layer comprises said multimodal polyethylene copolymer (P) in an amount of from 55 to 95 wt. %, based on the total weight of the coating layer.

3. Extrusion coated substrate according to claim 1, wherein said multimodal polyethylene copolymer (P) is produced in the presence of a metallocene catalyst.

4. Extrusion coated substrate according to claim 1, wherein said multimodal polyethylene copolymer (P) comprises a copolymer of ethylene and 1-butene and/or a copolymer of ethylene and 1-hexene.

5. Extrusion coated substrate according to claim 1, wherein fraction (A) of said multimodal polyethylene copolymer (P) comprises a bimodal copolymer of ethylene and 1-butene.

6. Extrusion coated substrate according to claim 1, wherein fraction (B) of said multimodal ethylene copolymer (P) comprises a copolymer of ethylene and 1-hexene.

7. Extrusion coated substrate according to claim 1, wherein said first fraction (A) comprised in the multimodal polyethylene copolymer (P) is a bi- or multimodal polyethylene copolymer and comprises a first polyethylene homo- or copolymer fraction (A-1) having a density of from 920 to 960 g/m³ and a MFR₂ of from 1 to 20 g/10 min; and a second polyethylene homo- or copolymer fraction (A-2) having a density of from 930 to 950 kg/m³ and a MFR₂ of from 3 to 40 g/m³.

8. Extrusion coated substrate according to claim 1, wherein said multimodal polyethylene copolymer (P), comprises or consists of
(i) 30.0 to 70.0 wt % of an polyethylene-1-butene polymer component (A), and
(ii) 70.0 to 30.0 wt % of an polyethylene-1-hexene polymer component (B),
wherein the polyethylene-1-butene polymer component (A) has a density in the range of from 920 to 950 kg/m³, an MFR₂ (190 °C, 2.16 kg, ISO 1133) in the range of from 2.0 to 40.0 g/10 min, a 1-butene content in the range of 0.5 to 5.0 wt %, based on the polyethylene-1-butene polymer component (A); and
wherein polyethylene-1-butene polymer component (A) consists of an polyethylene polymer fraction (A-1) and an polyethylene polymer fraction (A-2),
wherein the polyethylene polymer fraction (A-1) has a density in the range of 920 to 960 kg/m³; and a MFR₂ (190 °C, 2.16 kg, ISO 1133) in the range of 1.0 to 20.0 g/10 min, and
the polyethylene polymer fraction (A-2) has a density in the range of from 930 to 950 kg/m³, and a MFR₂ (190 °C, 2.16 kg, ISO 1133) in the range of 3.0 to 40.0 g/10 min; and
the polyethylene-1-hexene polymer component (B) has a density in the range of from 880 to 915 kg/m³, an MFR₂ (190 °C, 2.16 kg, ISO 1133) in the range of from 0.01 to 1.5 g/10 min, a 1-hexene content in the range of 15.0 to 25.0 wt % based on the polyethylene-1-hexene polymer compound (B); and
wherein the multimodal polyethylene copolymer (P) has a density in the range of from 905 to 915 kg/m³, an MFR₂ (190 °C, 2.16 kg, ISO 1133) in the range of from 0.5 to below 2.0 g/10 min and a ratio of the MFR₂₁ (190 °C, 21.6 kg, ISO 1133) to MFR₂ (190 °C, 2.16 kg, ISO 1133), MFR₂₁/MFR₂, in the range of from 22 to 50.

9. An extrusion coated substrate comprising:
a machine direction oriented polyethylene (MDO PE) substrate with a thickness in the range of from 10 to 200 μm and a tensile modulus in machine direction in a range of from 300 to 2000 MPa determined according to ISO 527-3;
a coating layer comprising
60 to 99 wt. % of a multimodal metallocene low linear density polyethylene (mLLDPE) homo- or copolymer (Px) having a density in a range of from 910 to 920 kg/m³ and MFR₂ of 0.5 to 20 g/10 min; and
1 to 40 wt. % of a low density polyethylene (C) having a density of 910 to 925 kg/m³ and MFR₂ of 2 to 40 g/10 min;
wherein a ratio MFR_{2(C)} to MFR_{2(P)} is greater than 1.

10. Extrusion coated substrate according to claim 9, wherein said multimodal metallocene low linear density polyethylene (mLLDPE) homo- or copolymer (Px) is a multimodal ethylene copolymer (P) having a MFR₂ of from 0.5 to 20 g/10 min, a density of from 910 to 915 kg/m³ and comprising:
a first bi- or multimodal polyethylene copolymer fraction (A) having a density of from 920 to 950 kg/m³, a MFR₂ of from 2 to 200 g/10 min and a comonomer content of from 0.5 to 5 wt %, and
a second polyethylene homo- or copolymer fraction (B) having a density of from 880 to 915 kg/m³, a MFR₂ of from 0.01 to 6 g/10 min and a comonomer content of from 15 to 25 wt. %

11. Extrusion coated substrate according to claim 1, wherein the coating layer is present in the extrusion coated substrate in an amount of from 5 to 50 g/m².

12. Extrusion coated substrate according to claim 1, comprising at least 90 wt. %, based on the total weight of the extrusion coated substrate, polyethylene homo- or copolymers.

13. Process for producing an extrusion coated substrate comprising extruding a coating composition onto a substrate to obtain the extrusion coated substrate, wherein said coating composition comprises:
a multimodal polyethylene copolymer (P) having an MFR₂ of from 0.5 to 20 g/10 min, a density of from 910 to 915 kg/m³ and comprising:
a first bi- or multimodal polyethylene copolymer fraction (A) having a density of 920 to 950 kg/m³, MFR₂ of 2 to 200 g/10 min and a comonomer content of from 0.5 to 5 wt. %, and
a second polyethylene homo- or copolymer fraction (B) having a density of 880 to 915 kg/m³; MFR₂ of 0.01 to 6 g/10 min and comonomer content of from 15 to 25 wt. %; and
wherein a ratio MFR₂₁/MFR₂ of said multimodal polyethylene homo- or copolymer (P) is in a range of from more than 20 to 100.

14. Process according to claim 13, wherein the substrate comprises a polyethylene homo- or copolymer film, preferably a machine-direction oriented ethylene homo- or copolymer film.

15. (canceled)

16. The substrate of claim 2, wherein the coating layer comprises said multimodal polyethylene copolymer (P) in an amount of from 60 to 90 wt. %, based on the total weight of the coating layer.

17. The substrate of claim 2, wherein the coating layer comprises said multimodal polyethylene copolymer (P) in an amount of from 65 to 85 wt. %, based on the total weight of the coating layer.

18. The substrate of claim 12, comprising at least 95 wt. % polyethylene homo- or copolymers based on the total weight of the extrusion coated substrate.

19. The substrate of claim 12, consisting of polyethylene homo- or copolymers.
